(19) United States
(12) Patent Application Publication
(10) Pub. No.: US 2015/0138633 A1
(43) Pub. Date: May 21, 2015

(54) SCOPE ATTACHMENT

(71) Applicant: SUPAS LTD, Hong Kong (CN)

(72) Inventors: Hermann Theisinger, Vienna (AT); Zhao Wang, Shanghai (CN)

(73) Assignee: SUPAS LTD, Hong Kong (CN)

(21) Appl. No.: 14/550,584

(22) Filed: Nov. 25, 2014

Related U.S. Application Data
(60) Provisional application No. 61/907,135, filed on Nov. 21, 2013.

(51) Int. Cl. G02B 23/16; F41G 1/38

(52) U.S. Cl. CPC G02B 23/16; F41G 1/38
USPC 359/399

(57) ABSTRACT

To improve the flexibility of a scope, such as a riflescope, spotting scope, and the like, a holder is mounted forward of the scope. The holder allows connection of a lens system, such as a wide angle lens system for improving the viewing angle. The holder may be mounted on a rail, such as a standard Picatinny rail, or may include a ring locking mechanism that engages and locks onto the outer scope housing.

### FIELD OF THE INVENTION

The present invention relates to attachments for scopes and in particular, though not exclusively, for firearm scopes and spotting scopes.

### BACKGROUND

The user of a telescopic sight on a firearm typically has to choose one specific optical power setting (fixed power) or a specific zoom range (variable power scope) thus limiting the application range of the telescopic sight to specific shooting distances. At the same time users need as much field-of-view as possible while maintaining a safe eye relief. In order to stretch the zooming range and/or field-of-view manufacturers have recently started to market riflescopes with stretched zooming range (so called super-zooms with 5-, 6-, 8- and 10-times zoom factor systems) and wide field-of-views. Such systems typically use more lens elements than conventional designs which also has the side effect of making the light path far more strained. This results in significantly heavier and far more costly products with reduced light transmission overall. Similar problems exists with non-firearm scopes such as observation optics, spotting scopes and the like.

What is required is a system and method for improving the adaptability of fixed power or variable power scope systems.

### SUMMARY OF ONE EMBODIMENT OF THE INVENTION

### Advantages of One or More Embodiments of the Present Invention

The various embodiments of the present invention may, but do not necessarily, achieve one or more of the following advantages:

the ability to modify the optical properties of a scope;

provide an ability to increase the magnification of a scope;

provide an ability to modify the field of view of a scope;

provide a wide field of view without significantly decreasing eye relief;

provide a holder for an optical component system that may be removably fitted to a scope without tools; and

provide a holder for an optical component that can be fitted to a range of scope sizes.

These and other advantages may be realized by reference to the remaining portions of the specification, claims, and abstract.

### Brief Description of One Embodiment of the Present Invention

In one aspect, there is provided an optical device for improving the field of a scope. The optical device may include a wide angle lens system comprising one or more optical elements. The wide angle lens system may be mounted forward of an objective end of a scope by a mount.

In one aspect of the present invention, there is a provided an attachment for improving the field of view of a scope. The attachment may comprise a holder for mounting to an objective end of a scope. A wide angle lens system comprising one or more optical elements may be supported by the holder. The holder may attach to the objective end of a scope such that light entering the scope through the objective end is first altered by the wide angle lens system.

In one aspect of the present invention, there is a provided a holder for attaching an optical accessory onto a scope. The holder comprises a first ring comprising a variable internal dimension. The holder may also comprise a mount for mounting a lens system to the holder such that the lens system is placed in front of an objective end of the scope when the holder is attached to the scope.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 substantially shows a scope and a holder prior to assembly;

FIG. 2 substantially shows a holder secured onto the scope;

FIG. 3 substantially shows a lens system mounted in front of an objective lens of a scope;

FIG. 4 substantially shows a lens system with a screw thread that engages an internal screw thread of the scope objective;

FIG. 5 substantially shows an alternative holder;

FIG. 6 substantially shows internal locking elements of the holder of FIG. 6;

FIG. 7 substantially shows a locking element in an open configuration;

FIG. 8 substantially shows the locking element in a tightened configuration;

FIG. 9 substantially shows the holder of FIG. 6 secured to a scope objective; and

FIG. 10 substantially shows a lens system mounted forward of a riflescope on a Picatinny rail.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

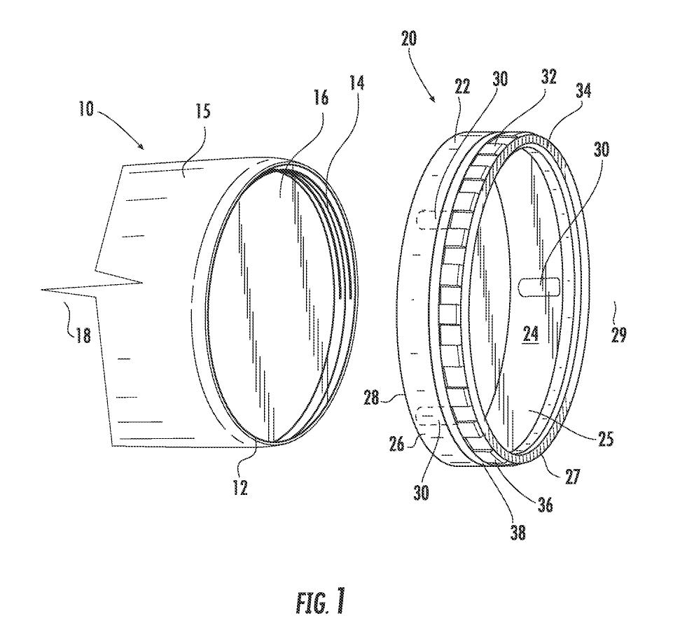

In FIG. 1, there is shown a scope for a firearm, spotting scope, battle scope or the like generally indicated by reference numeral 10. Typically, the scope includes an objective end (front) 12 and an ocular end (back) (not shown). The objective end 12 comprises an outer housing 15 of approximately consistent diameter, though a consistent diameter is not essential for the working of the invention. The size of the housing 15 at the objective end is determined by the diameter of the objective lens 16 within. Typical objective lenses include 30 mm, 32 mm, 40 mm and 42 mm though objective lens diameters may have a range of sizes and thus the housing may also have a range of sizes. The scope 10 has a longitudinal axis extending generally in the direction from the objective end 12 to the ocular end 15 as indicated by the axial line 18. The scope 10 may have an inner thread 14 at the front edge to receive screw on filters or other screw on optical components.

FIG. 1 shows a holder for use with the scope 10. The scope 10 may be a riflescope and may be mounted to a rifle using known methods, such as a Picatinny rail. Alternatively, the scope 10 may be a free standing scope such as a spotting scope or the like. The holder, shown generally at 20, is adapted to slide over the objective end 12 of the scope housing 15. The holder 20 includes a first ring 22 having an inner aperture 24 that is sized to slide over the scope housing 15. The first ring 22 has an inner surface 25 and an outer surface 26. The inner surface 25 defines internal dimensions such as an inner diameter and an inner circumference. The first ring 22 has a front edge 27 and a rear edge 28. The ring 22 is approximately centered about a longitudinal axis 29 that extends from the front 27 to the rear 28 of the ring 22.

On the inner surface 25 of the ring 22, there may be a plurality of circumference adjustment elements or locking elements 30. The locking elements 30 are disposed on the ring 22 to be able to move longitudinally. As the locking elements 30 move longitudinally from the front to the back, the locking elements also move towards the center of the ring 22, thereby reducing the effective inner circumference of the ring. In one embodiment, the locking elements 30 have a composite wedge profile. In one embodiment, three locking elements 30 are disposed evenly around the inner circumference of the holder ring 22, though any number of locking elements 30 may be used.

The holder 20 includes a locking ring 32. The locking ring 32 may have a knurled outer circumferential surface 36 that facilitates grip for the user to aid in rotation of the locking ring 32. The locking ring 32 may be secured onto the first ring 22 of the holder 20 towards the front edge 27 of the holder by a mutual thread engagement 38 formed on the outer surface 26 of the holder ring 22 and the inner surface of the locking ring 32. As the locking ring 32 is wound further onto the holder ring 22, the locking ring 32 presses against a front edge of the locking elements 30, thereby urging the locking elements 30 longitudinally toward the back of the holder 20 and, consequently, causing the locking elements 30 to reduce the effective inner circumference and/or diameter of the holder ring 22.

The holder 20 further includes a mount 34 for securing a lens system, filter or other optical component to the holder 20 such that the lens system is secured forward of an objective end of the scope. In one embodiment, the mount includes a screw thread formed on an inner front surface of the holder 22, e.g. on an inner front surface of the locking ring 32. Alternative mounts may include clip on lens mounts, bayonet fittings, etc.

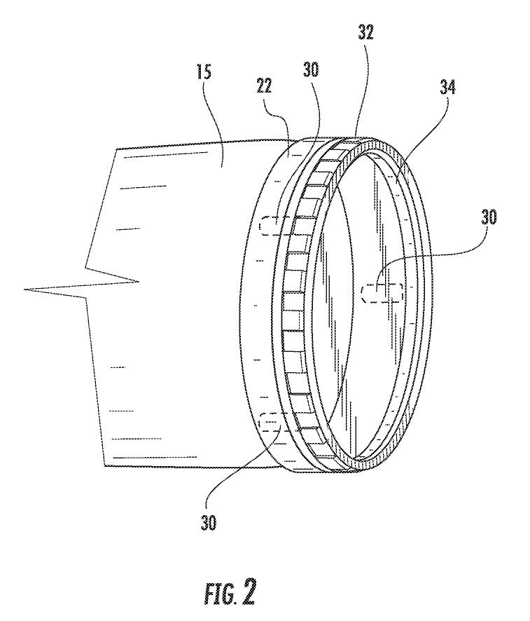

As is shown in the assembled device of FIG. 2, the holder 20 provides a slide-on adapter that is able to fix and center a filter, lens or other accessory onto a telescope. The locking elements 30 and locking ring 32 together provide a means for securing the holder 20 onto a scope body 15. Initially, the holder 20 may slide onto the scope body 15 and then be secured in place by turning the locking ring 32 until the locking elements 30 securely engage the scope body 15. The locking elements 30 may have a rubberized or friction enhanced surface that facilities grip with the scope housing 15 and prevents any marking on the scope housing 15. The use of the locking mechanism herein described allows the holder to have a variable inner dimension that can suit scopes having a range of objective sizes. The degree of variation accommodated by a single holder may depend on the shape and configuration of the locking elements, but in one embodiment a first holder may be sized to accommodate objectives from 40-42 mm while a second holder may be sized to accommodate objectives from 30-32 mm.

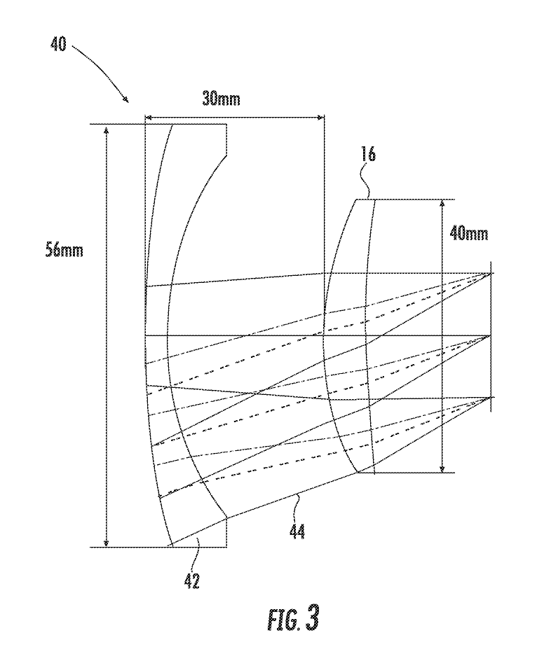

In one embodiment, the lens system may be a wide angle lens system. An example wide angle lens system is depicted generally at 40 in FIG. 3. The wide angle lens system 40 includes one or more lens elements 42 (e.g. negative objective). Example light paths 44 illustrating how the lens 42 alters the light entering the scope objective 16 are depicted in FIG. 3. The lens element 42 may be mounted within a housing (not shown) that has a screw thread fitting that complements the screw thread mount 34 of the holder 24. The lens system 40 thus may be mounted to the holder 20 and subsequently positioned in front of a telescopic system (example rifle scope objective 40 mm) for reducing the focal length in order to enhance the field-of-view. In the example of FIG. 3, the wide angle lens has a diameter of 56 mm with the front plane of the lens 42 set 30 mm in front of the front plane of the objective lens 16 having an objective lens diameter of 40 mm. Other configurations will be apparent to the person skilled in the art.

In one embodiment, the lens or lens system may be coated for normal visible light use (400-700 Nm) yet at the same time be enhanced in transmission beyond the visible light spectrum thus allowing for a more than 80% light transmission ratio per air-to-glass surface.

In one embodiment, the lens or lens systems may be optimized by one or more coatings or selection of lens materials for night vision use, e.g the non-visible infrared wavelength range from approx 850 nm to approx 1050 nm.

In one embodiment, the lens or lens system may be configured to work with telescopic zoom-products with 1-times, 1.1-times, 1.5-times, 2-times, 2.5-times, 3-times minimum magnification. For spotting applications, the lens or lens systems may be configured to work with spotting scopes or similar products with magnification in the order of 8-times, 10-times, 15-times, 20-times and greater.

In one embodiment, the lens or lens system may be calculated for fixed power telescopes in the magnification range of 1.1-power to 12-power and up to of the order of 30 power for spotting applications.

In one embodiment, the lens or lens system may be calculated for non-telescopic optical devices such as red-dot sights with an approximate 0.7-power to 1.1-power magnification.

In one embodiment, the lens or lens system may be configured with an entry pupil of 19 mm to 73 mm.

In one embodiment, the lens or lens system may utilize one or more non-glass material lenses such as plastic lenses used in the photographic industry.

The presently described embodiments demonstrate how to convert a fixed power scope into a lower-power product with a wider field-of-view or into a higher-power product by means of a lens element or a lens group mounted onto the objective bell. Accordingly the present innovation allows for shifting the zooming range of a variable power scope either downwards towards lower magnification and wider field-of-views or upwards towards higher magnification and higher shooting precision.

The holder 20 can be used to reduce the magnification of optical products while enhancing the field-of-view. By attaching the holder 20 with a suitable wide angle lens 42 fitted to the mount 34, the user is able to ‘convert’ any 3-9×40 scope into a e.g. 2-7×40 scope with a ca. 30% wider field-of-view than before.

The holder 20 is able to provide precise centering of the optical elements thereby reducing any tracking out error of the reticle versus the impact point (optical shift). The precise centering also reduces the optical deterioration effect caused by the lens components in terms of aberration, Coma and other optical performance parameters.

The holder concept solves the problem of diverse objective size and thread standards by allowing for attachment onto entire product classes such as 40 mm to 42 mm-standard riflescopes (or 30 mm to 32 mm, etc.). The holder concept allows for fast and simple attachment of other accessory such as filters, hand lamps, laser-pointers, etc. onto any rotational symmetric optical product.

Because common filter thread solutions are not standardized across the various manufacturers or product lines, dealers have to carry a large number of different brand-fit solutions on stock to support the large number of different outer diameter or filter thread standards. The present concept works with any—for example—40 mm and even 42 mm (30/32 etc.) objective with a tolerance of several millimeters in variance.

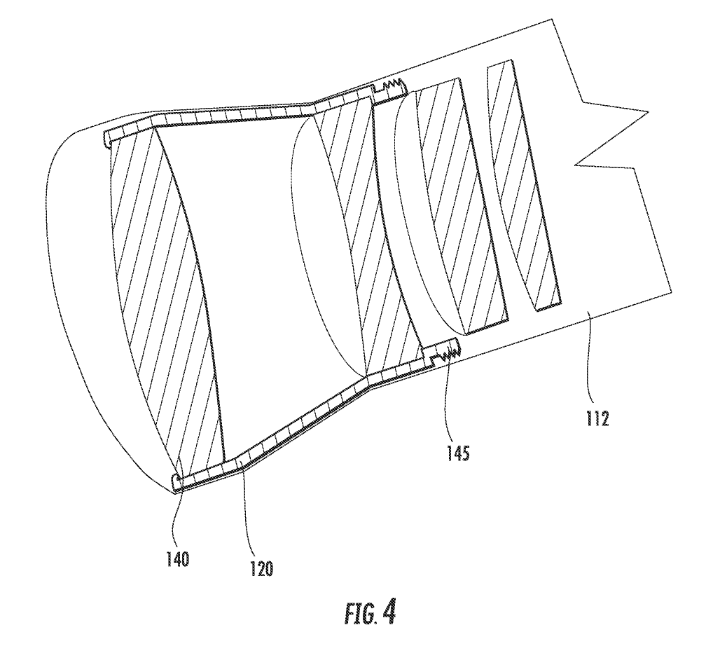

FIG. 4 shows an alternative embodiment where the lens system 140 within a holder 120 is able to screw into the objective end 112 by a connect thread 145.

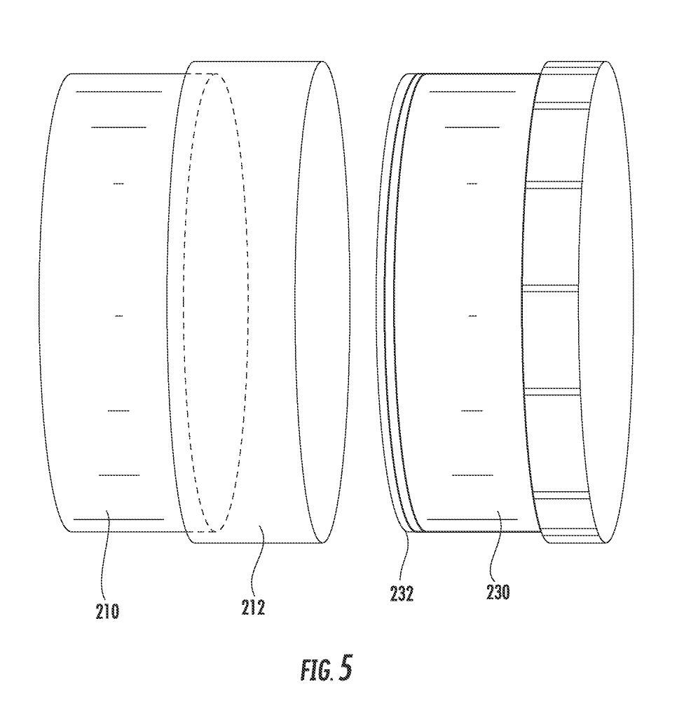

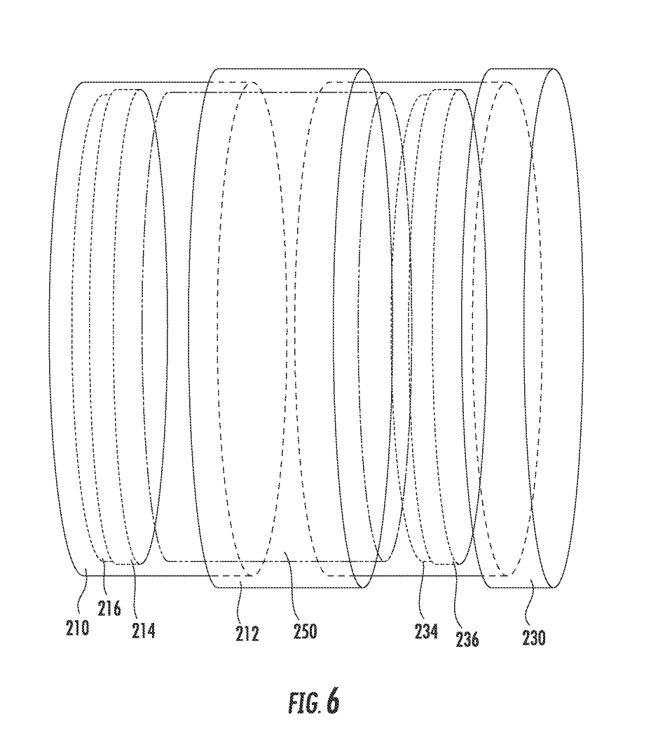

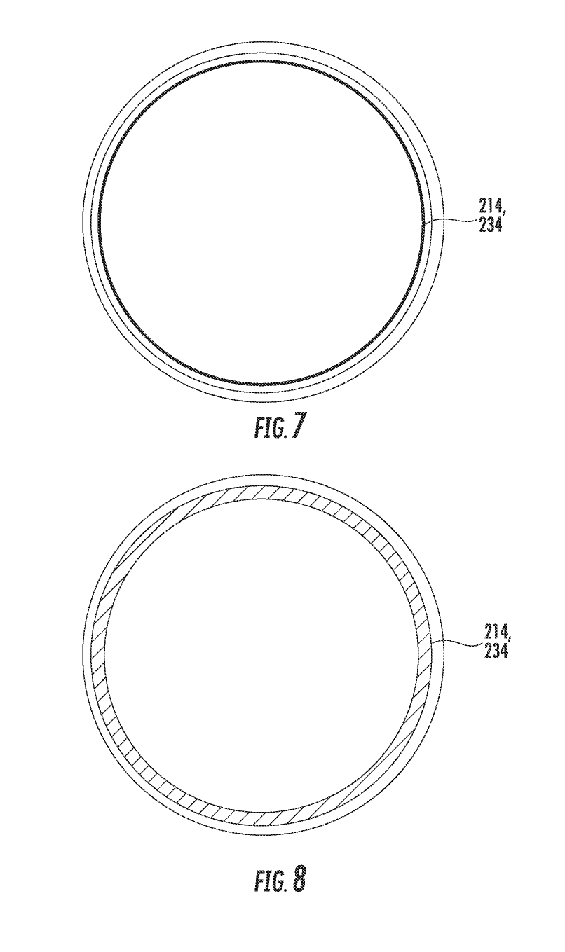

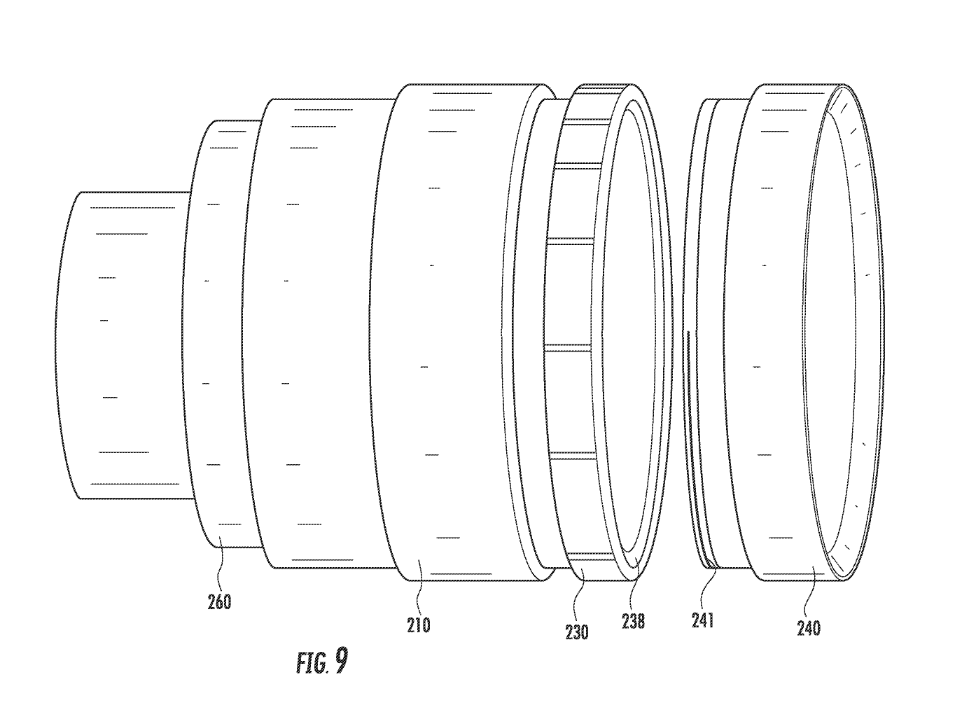

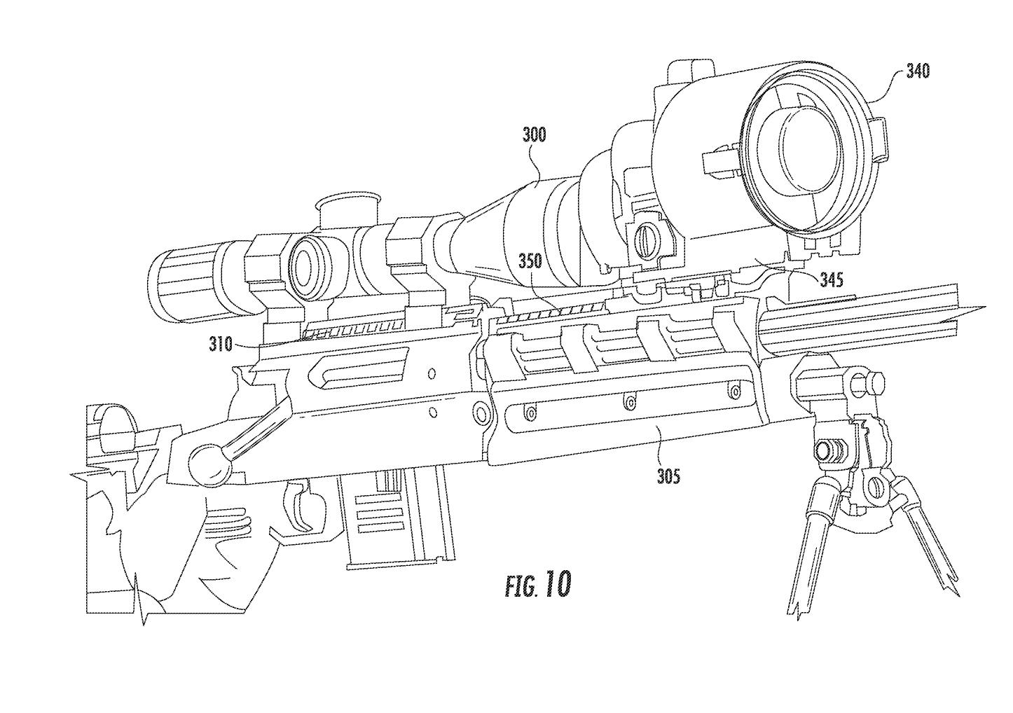

FIGS. 5 to 9 illustrate an alternative embodiment for connection of a lens system 40 via a holder 200. FIG. 5 shows a base ring 210 and a locking ring 230. The locking ring 230 fits within an outer sleeve 212 of the base ring and engages the base ring by a thread 232. Within each of the base ring 210 and locking ring 230 is a locking element, such as a flexible o-ring. The base ring o-ring 214 engages a base stop 216 and the locking ring o-ring 234 engages a locking ring stop 236. Each of the stops 216, 236 limit the ability of the o-rings 214, 234 to move within their respective chambers. A sleeve 250 is provided between the o-rings 214, 234 and is initially able to move freely between the o-rings 214, 234. When the locking ring 230 is tightened within the base ring 210, the distance between the stops 216, 236 is shortened until the sleeve 250 presses against each of the o-rings 214, 234. Further tightening of the locking ring 230 causes the o-rings to expand inward, thereby reducing the internal diameter of the holder 200. FIG. 7 shows the o-rings 214, 234 in with the lock ring loose while FIG. 8 shows the o-rings 214, 234 with the locking ring 230 having been tightened to reduce the internal dimension of the holder 200. In this manner, the holder 200 can be secured to the outer housing surface of the objective end of scope 260. The lens system 240 can be secured by a locking thread 241 into a locking thread 2338 at the outer end of the locking ring 230.

FIG. 10 illustrates an alternative embodiment for mounting the lens system 40 forward of the scope. In this embodiment, a scope 300 is mounted on a rifle 305 by a Picatinny rail 310. The lens system 340 is provided with a bracket 345 that mounts the lens system 340 to a second Picatinny rail 350, thereby disposing the lens system 340 forward of the objective end of the scope 300. Other methods of mounting the lens system 340 in front of the riflescope 300 will be apparent to the person skilled in the art.

While the invention has been described herein with particular reference to riflescopes other embodiments are contemplated. In one alternative embodiment, the scope enhancement device may be used in conjunction with a spotting scope. Spotting scopes typically have higher powers than riflescopes, such as in the range of 10×-30× and even greater. Such scopes are particularly suitable for the field of view enhancements offered by the present invention.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

What is claimed is:

1. An optical device for improving the field of view of a scope comprising:
(A) a lens system comprising one or more optical elements;
(B) a holder that secures the lens system and mounts the lens system forward of an objective end of the scope such that light entering the scope through the objective end is first altered by the wide angle lens system.

2. The optical device of claim 1 wherein the holder comprises:
(A) a bracket that holds the lens system;
(B) a rail that receives and engages the bracket.

3. The optical device of claim 1 wherein the holder is configured to be received over an objective end of the scope, the holder comprising a mount for securing the lens system.

4. The optical device of claim 3 wherein the holder comprises a first ring comprising a variable internal dimension, the first ring configured to be received over an objective end of the scope.

5. The optical device of claim 4 wherein the first ring comprises one or more circumference adjustment elements that move to adjust an inner circumference of the first ring to thereby tighten the first ring on the scope.

6. The optical device of claim 5 comprising a second ring rotatable with respect to the first ring, wherein rotation of the second ring moves the one or more circumference adjustment elements.

7. The optical device of claim 3 wherein the holder comprises at least one internal o-ring that engages an outer surface of the scope.

8. The optical device of claim 7 comprising a tightening mechanism that tightens the at least one internal o-ring onto the scope.

9. A holder for attaching an optical accessory onto a scope, the holder comprising:
(A) a first ring comprising a variable internal dimension that engages an outer housing of a scope;
(B) a mount for mounting a lens system to the holder such that the lens system is placed in front of an objective end of the scope when the holder is attached to the scope.

10. The holder of claim 9 wherein the first ring is configured to be received over an objective end of the scope.

11. The optical device of claim 9 wherein the first ring comprises one or more circumference adjustment elements that move to adjust an inner circumference of the first ring to thereby tighten the first ring on the scope.

12. The optical device of claim 11 comprising a second ring rotatable with respect to the first ring, wherein rotation of the second ring moves the one or more circumference adjustment elements.

13. The optical device of claim 9 wherein the holder comprises at least one internal o-ring that engages an outer surface of the scope.

14. The optical device of claim 13 comprising a tightening mechanism that tightens the at least one internal o-ring onto the scope.

15. A system for enhancing a scope comprising:
(A) lens means for altering light passing to the scope; and
(B) holder means for attaching the lens means forward of the scope.

16. The system of claim 0 wherein the holder means comprises ring means for receiving the scope within the ring means.

17. The system of claim 16 comprising locking means for locking the ring means on the scope.
